(19) United States
(12) Patent Application Publication
(10) Pub. No.: US 2026/0209455 A1
(43) Pub. Date: Jul. 23, 2026

(54) METHOD FOR PRODUCING AMIDO-METHYLATED VINYL-AROMATIC POLYMERIZATES

(71) Applicant: LANXESS Deutschland GmbH, Cologne (DE)

(72) Inventor: Bernd Koop, Cologne (DE)

(73) Assignee: LANXESS Deutschland GmbH, Cologne (DE)

(21) Appl. No.: 19/140,145

(22) PCT Filed: Dec. 14, 2023
(86) PCT No.: PCT/EP2023/085755

§ 371 Date: Jun. 17, 2025

(30) Foreign Application Priority Data
Dec. 21, 2022 (EP) 22215280.3

(51) Int. Cl. C08J 7/02; C08F 26/02

(52) U.S. Cl. CPC C08J 7/02; C08F 26/02

(57) ABSTRACT

The invention relates to a process for preparing amidomethylated vinylaromatic polymers.

The invention relates to a process for preparing amidomethylated vinylaromatic polymers.

The preparation of amidomethylated vinylaromatic polymers has long been known. DE-A 2211134 discloses that crosslinked styrene bead polymers can be condensed with N-hydroxymethylphthalimide in the presence of swelling agents and Friedel-Crafts catalysts. Disadvantages of this process are that the N-hydroxymethylphthalimide must first be prepared from phthalimide, that water must be distilled off during the reaction, the hydrohalic acid must be added, and that the yield of the amidomethylated vinylaromatic polymers is unsatisfactory.

A further process for preparing amidomethylated vinylaromatic polymers in which phthalimide, paraformaldehyde and sulfuric acid are reacted in one step in the presence of 1,2-dichloroethane as swelling agent and the vinylaromatic bead polymer is known from U.S. Pat. No. 4,232,125. Different swelling agents as alternatives to 1,2-dichloroethane are mentioned therein. What is likewise disadvantageous about this process is that the yield of the amidomethylated vinylaromatic polymers is unsatisfactory.

A further one-step process for preparing amidomethylated vinylaromatic polymers in which the swelling agent used is 1,3-dichloropropane is known from EP-A 3012272. This swelling agent can be industrially separated from the product only by complex methods, and its use is therefore relatively costly. Moreover, 1,3-dichloropropane is a suspected carcinogen and is therefore not a possible swelling agent.

EP-B 3478727 discloses an amidomethylation process in the presence of benzotrifluoride. In this process, it has been found that hydrofluoric acid is formed, which leads to corrosion of the reactors, and this process is therefore likewise unusable.

EP-B 3581595 discloses a process in which the amidomethylation is performed in the presence of bromoalkyl derivatives. However, there is currently a discussion as to the extent to which these compounds also have toxic properties that could limit their use.

There was therefore still a need for a process which overcomes the disadvantages of the prior art, and with which amidomethylated vinylaromatic polymers can be prepared in good yields.

It has now been found that, surprisingly, the reaction of vinylaromatic polymers with condensed formaldehydes and protic acids in the presence of C₁-C₅-difluoroalkanes leads to amidomethylated vinylaromatic polymers with high yields.

The present invention therefore provides a process for preparing amidomethylated vinylaromatic polymers in which at least one vinylaromatic polymer is reacted with at least one compound of formula (I) or salts thereof

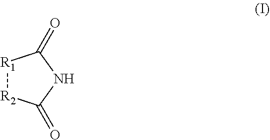

where R₁=—C(H(C₁-C₆-alkyl))- or —CH₂— and R₂=—C(H(C₁-C₆-alkyl))- or —CH₂— or R₁ and R₂ are two carbon atoms of an aromatic C₆ ring optionally substituted by one or two C₁-C₆-alkyl radicals, or R₁ and R₂ are each —CH═,
and at least one condensed formaldehyde in the presence of at least one protic acid and in the presence of at least one straight-chain or branched C₁-C₅-difluoroalkane or at least one cyclic C₅-difluoroalkane or mixtures of these compounds.

R₁ and R₂ preferably combine to form a C₁-C₆-alkyl-substituted aromatic C₆ ring. R₁ and R₂ more preferably form a benzene ring optionally substituted by C₁-C₄-alkyl. Compounds of formula (I) are very particularly preferably phthalimide, succinimide or maleimide. The compound of formula (I) is even further preferably phthalimide. When phthalimide is used, phthalimidomethylated polymers are prepared in accordance with the invention. Salts of the compounds of formula (I) are preferably understood to be addition products of inorganic or organic alkalis with compounds of formula (I), such as preferably ammonium salts and alkali metal or alkaline earth metal salts. Any salts used are more preferably the sodium and potassium salts of the compounds of formula (I).

C₁-C₆-alkyl and C₁-C₄-alkyl in the context of the invention are a straight-chain or branched or cyclic alkyl radical having 1 to 6 or 1 to 4 carbon atoms. For example and with preference, C₁-C₆-alkyl is methyl, ethyl, n-propyl, isopropyl, n-, i-, s- or t-butyl, cyclopropyl, n-propyl, 1-methylbutyl.

For example and with preference, C₁-C₆-alkyl is methyl, ethyl, n-propyl and isopropyl. C₁-C₅-difluoroalkane is preferably a C₁-C₃-difluoroalkane. C₁-C₅-difluoroalkane is, for example and with preference, difluoromethane, 1,1-difluoroethane, 1,2-difluoroethane, 1,1-difluoropropane, 1,2-difluoropropane, 1,3-difluoropropane, 1,1-difluorobutane, 1,2-difluorobutane, 1,3-difluorobutane, 1,4-difluorobutane, 2,3-difluorobutane, 1,3-difluoro-2-methylpropane, 1,1-difluoropentane, 1,2-difluoropentane, 1,3-difluoropentane, 1,4-difluoropentane, 1,5-difluoropentane, 2,3-difluoropentane, 2,4-difluoropentane and 1,5-difluoropentane or mixtures of these compounds. Cyclic C₅-difluoroalkanes are preferably 1,1-difluorocyclopentane and 1,2-difluorocyclopentane. More preferably, C₁-C₅-difluoroalkane is difluoromethane, difluoroethane and difluoropropane. Most preferably, C₁-C₅-difluoroalkane and C₁-C₃-difluoroalkane are difluoromethane and 1,3-difluoropropane.

C₁-C₅-difluoroalkanes and cyclic C₅-difluoroalkanes are swelling agents for the polymers, but likewise serve as solvents for the further reactants in the amidomethylation reaction. In the amidomethylation reaction, it is also possible to add further organic swelling agents. Further organic swelling agents added may, for example and with preference, be benzotrifluoride, dibromomethane, 1,2-dichloroethane, 1,2-dichloropropane, 1,3-dichloropropane, 1,4-dichlorobutane, 1,6-dichlorohexane, methylene chloride, carbon tetrachloride, trichloroethane, chlorobenzene, 1,2-dichlorobenzene, or nitro-substituted hydrocarbons, for example nitropropane, nitrobenzene or, for example, cyclic hydrocarbons, for example cyclohexane and methylcyclohexane. Preference is given to using no further swelling agents or/and solvents.

Preferably, the amount by weight of C₅-C₈-difluoroalkane and/or cyclic C₅-difluoroalkanes in swelling agents used is 80% by weight to 100% by weight. More preferably, the amount by weight of C₁-C₅-difluoroalkane and/or cyclic C₅-difluoroalkanes in swelling agents used is 90% by weight to 100% by weight. Most preferably, the amount by weight of C₁-C₅-difluoroalkanes and/or cyclic C₅-difluoroalkanes in swelling agents used is 98% by weight to 100% by weight.

Condensed formaldehyde means condensates of formaldehyde. Compounds of this type are prepared by customary methods known to a person skilled in the art. Compounds used as condensed formaldehydes include, for example and with preference, those of formula (11)

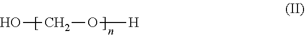

in which n=8 to 100. Preference is given to using compounds of formula (11) in which n=8 to 30.

But it is also possible to use cyclic condensates, for example trioxane. The condensed formaldehyde used is more preferably paraformaldehyde or trioxane, or mixtures of these compounds. The condensed formaldehyde used is most preferably paraformaldehyde.

Protic acids used may, for example, be inorganic or organic protic acids. Inorganic protic acids used are, for example, hydrochloric acid, sulfuric acid, oleum, nitric acid, nitrous acid, sulfurous acid, aliphatic or aromatic methane-, benzene- or toluenesulfonic acids, or phosphoric acid. Organic protic acids used may, for example, be oxalic acid, acetic acid or formic acid. Preference is given to using inorganic protic acids. Protic acids used are more preferably sulfuric acid or oleum.

The polymers of the invention are preferably spherical. The polymers preferably have a diameter of 200 μm to 1000 μm. Polymers in bead form are referred to as bead polymers.

The term “vinylaromatic” in the context of the invention includes polyvinylaromatic and monovinylaromatic monomers. The vinylaromatic polymers are prepared using at least one monovinylaromatic compound and at least one polyvinylaromatic compound, for example. However, it is also possible to use mixtures of two or more monovinylaromatic compounds and mixtures of two or more polyvinylaromatic compounds. Preference is given to preparing the vinylaromatic polymers by using at least one monovinylaromatic compound and at least one polyvinylaromatic compound.

Monovinylaromatic compounds used in the context of the present invention are preferably styrene, vinyltoluene, ethylstyrene, α-methylstyrene, chlorostyrene and chloromethylstyrene.

Particular preference is given to using styrene or mixtures of styrene with the aforementioned monomers.

Preferred polyvinylaromatic compounds in the context of the present invention are divinylbenzene, divinyltoluene, trivinylbenzene, triallyl isocyanurate, divinylnaphthalene or trivinyinaphthalene.

The polyvinylaromatic compounds are preferably used in amounts of 1-20% by weight, more preferably in amounts of 2-12% by weight, most preferably 4-10% by weight, based on the monomer or mixture thereof with further monomers. The type of polyvinylaromatic compounds (crosslinker) is selected with regard to the later use of the polymer. Divinylbenzene is suitable in many cases. Commercial divinylbenzene grades which, in addition to the isomers of divinylbenzene, also contain ethylvinylbenzene are sufficient for most applications.

In a preferred embodiment, the vinylaromatic polymers are styrene/divinylbenzene-crosslinked copolymers.

In a preferred embodiment of the present invention, microencapsulated monomer droplets are used.

Possible materials for the microencapsulation of the monomer droplets are those known for use as complex coacervates, especially polyesters, natural and synthetic polyamides, polyurethanes, polyureas.

Being a natural polyamide, gelatin, for example and with preference, is of particularly good suitability. This is employed especially as a coacervate and complex coacervate. For the purposes of the invention, gelatin-containing complex coacervates are especially understood to mean combinations of gelatin with synthetic polyelectrolytes. Suitable synthetic polyelectrolytes are copolymers incorporating units of, for example, maleic acid, acrylic acid, methacrylic acid, acrylamide and methacrylamide. Particular preference is given to using acrylic acid and acrylamide. Gelatin-containing capsules can be hardened with conventional hardeners, such as formaldehyde or glutardialdehyde. The encapsulation of monomer droplets with gelatin, gelatin-containing coacervates and gelatin-containing complex coacervates is described in detail in EP-A 0 046 535. The methods for encapsulation with synthetic polymers are known. An example of a highly suitable method is that of phase interface condensation where a reactive component, for example an isocyanate or an acyl chloride, dissolved in the monomer droplet, is made to react with a second reactive component, for example an amine, dissolved in the aqueous phase.

The optionally microencapsulated monomer droplets optionally contain an initiator or mixtures of initiators to induce the polymerization. Suitable initiators for the process of the present invention are preferably peroxy compounds such as dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane or tert-amylperoxy-2-ethylhexane, and also azo compounds such as 2,2′-azobis(isobutyronitrile) or 2,2′-azobis(2-methylisobutyronitrile). Most preferably, dibenzoyl peroxide is used.

The initiators are preferably used in amounts of 0.05% to 2.5% by weight, more preferably in amounts of 0.1% to 1.5% by weight, based on the monomer mixture.

Porogens may optionally be used as further additives in the optionally microencapsulated monomer droplets in order to generate a macroporous structure in the polymer. Suitable porogens include organic solvents that are poor solvents and/or swellants for the polymer formed. Preference is given to hexane, octane, isooctane, isododecane, methyl ethyl ketone, butanol or octanol and isomers thereof. Particular preference is given to using isododecane as porogen. Preference is given to using porogens in the preparation of the amidomethylated vinylaromatic polymers of the invention.

The terms “microporous” and “in gel form”/“macroporous” have already been described in detail in the technical literature.

Preferred polymers for the purposes of the present invention have a macroporous structure.

What is preferably meant by “macroporous” in the context of the invention is that the average diameter of the pores in the polymer is ≥25 nm. More preferably, the pores in the polymer of the macroporous polymers have an average diameter of 30 nm to 1000 nm. Most preferably, the pores in the polymer of the macroporous polymers have an average diameter of 30 nm to 100 nm.

What is meant by “in gel form” in the context of the invention is that the BET surface area is ≤2 m²/g. The BET surface area in the case of polymers in gel form is preferably 0.02 m²/g to 2 m²/g.

The optionally microencapsulated monomer droplet may optionally also contain up to 30% by weight (based on the monomer) of crosslinked or uncrosslinked polymer. Preferred polymers derive from the aforementioned monomers, particularly preferably from styrene.

Polymers can be prepared in heterodisperse or monodisperse form. The preparation of heterodisperse polymers is accomplished by general processes known to those skilled in the art, for example with the aid of suspension polymerization.

Preference is given to preparing monodisperse vinylaromatic polymers in the process of the invention.

In the present application, monodisperse materials are those in which at least 90% by volume or 90% by mass of the particles have a diameter within ±10% of the most common diameter.

For example, in the case of a material having a most common diameter of 0.5 mm, at least 90% by volume or 90% by mass is within a size interval between 0.45 mm and 0.55 mm; in the case of a material having a most common diameter of 0.7 mm, at least 90% by volume or 90% by mass is within a size interval between 0.77 mm and 0.63 mm.

The monodisperse polymer can be prepared by the methods known from the literature. The aqueous phase involved in preparing monodisperse vinylaromatic polymers may optionally contain a dissolved polymerization inhibitor. Preferably, the aqueous phase does contain a dissolved polymerization inhibitor. Both organic and inorganic inhibitors are useful for the purposes of the present invention. Examples of inorganic inhibitors are nitrogen compounds such as hydroxylamine, hydrazine, sodium nitrite and potassium nitrite, salts of phosphorous acid such as sodium hydrogenphosphite, and also sulfur compounds such as sodium dithionite, sodium thiosulfate, sodium sulfite, sodium bisulfite, sodium thiocyanate and ammonium thiocyanate. Examples of organic inhibitors are phenolic compounds such as hydroquinone, hydroquinone monomethyl ether, resorcinol, catechol, tert-butylcatechol, pyrogallol and condensation products of phenols with aldehydes. Suitable organic inhibitors further include nitrogen compounds. These include hydroxylamine derivatives such as, for example, N,N-diethylhydroxylamine, N-isopropylhydroxylamine and also sulfonated or carboxylated N-alkylhydroxylamine or N,N-dialkylhydroxylamine derivatives, hydrazine derivatives such as, for example, N,N-hydrazinodiacetic acid, nitroso compounds such as, for example, N-nitrosophenylhydroxylamine, N-nitrosophenylhydroxylamine ammonium salt or N-nitrosophenylhydroxylamine aluminum salt. The concentration of the inhibitor is preferably 5-1000 ppm, based on the aqueous phase, more preferably 10-500 ppm and even further preferably 10-250 ppm. Preference is given to using resorcinol as polymerization inhibitor. Preference is given to using a polymerization inhibitor.

The polymerization of the optionally microencapsulated monomer droplets to form the monodisperse vinylaromatic polymer is optionally carried out, as already mentioned above, in the presence of one or more protective colloids in the aqueous phase. Useful protective colloids include natural or synthetic water-soluble polymers, for example, gelatin, starch, polyvinyl alcohol, polyvinylpyrrolidone, polyacrylic acid, polymethacrylic acid or copolymers formed from (meth)acrylic acid and from (meth)acrylic esters. Very useful protective colloids further include cellulose derivatives, in particular cellulose esters and cellulose ethers, such as carboxymethylcellulose, methylhydroxyethylcellulose, methylhydroxypropylcellulose and hydroxyethylcellulose. Gelatin is of particularly good suitability and is used with preference. The amount of the protective colloids used is preferably 0.05% to 1% by weight, based on the aqueous phase, more preferably 0.05% to 0.5% by weight.

The polymerization to form the monodisperse vinylaromatic polymer may optionally also be carried out in the presence of a buffer system. Preference is given to buffer systems which adjust the pH of the aqueous phase at the start of the polymerization to a value between 14 and 6, preferably from 12 to 8. Under these conditions, protective colloids having carboxylic acid groups are wholly or partly present as salts. This has a favourable effect on the action of the protective colloids. Particularly well-suited buffer systems contain phosphate or borate salts. For the purposes of the invention, the terms “phosphate” and “borate” also encompass the condensation products of the ortho forms of corresponding acids and salts. The concentration of the phosphate/borate in the aqueous phase is preferably 0.5-500 mmol/l, more preferably 2.5-100 mmol/l.

The stirrer speed in the polymerization is less critical and has no effect on particle size. Low stirrer speeds sufficient to keep the suspended monomer droplets in suspension and to promote the removal of the heat of polymerization are employed. Various stirrer types can be used for this task. Particularly suitable stirrers are axial-action gate stirrers.

The volume ratio of encapsulated monomer droplets to aqueous phase is preferably 1:0.75 to 1:20, more preferably 1:1 to 1:6.

The polymerization temperature depends on the decomposition temperature of the initiator used. It is preferably between 50° C. and 180° C., more preferably between 55° C. and 130° C. The polymerization preferably lasts for 0.5 hour to a few hours. It has been found to be useful to employ a temperature program in which the polymerization is commenced at low temperature, for example 60° C., and the reaction temperature is raised with increasing polymerization conversion. In this way, for example, the requirement for reliable running of the reaction and high polymerization conversion can be fulfilled very efficiently. After the polymerization, the polymer is isolated by conventional methods, preferably by filtering or decanting, and optionally washed.

The vinylaromatic polymer is reacted with at least one compound of formula (I), at least one condensed formaldehyde in the presence of C₁-C₅-difluoroalkane or cyclic C₅-difluoroalkanes or mixtures of these compounds and in the presence of at least one protic acid, to form the amidomethylated vinylaromatic polymer.

For example, the vinylaromatic polymer may first be swelled in the presence of a C₁-C₅-difluoroalkane and/or cyclic C₅-difluoroalkane and mixed in this state with a mixture formed from the compounds of formula (I), from the condensed formaldehyde and from the protic acids. However, it would be equally possible first to add the compounds of formula (I) to the crosslinked polymer in the presence of a C₁-C₅-difluoroalkane and/or cyclic C₅-difluoroalkane and then to add the condensed formaldehyde and then the protic acids. Or the protic acid is added to an initial charge of the compounds of formula (I), the condensed formaldehyde, the C₁-C₅-difluoroalkane and/or cyclic C₅-difluoroalkane, and then the vinylaromatic polymer is added thereto. Preferably, the crosslinked polymer is first swelled in the presence of the C₁-C₅-difluoroalkane and/or of the cyclic C₅-difluoroalkane and then the compounds of formula (I) or the condensed formaldehyde are added and then the protic acid is added. The C₁-C₅-difluoroalkane and/or the cyclic C₅-difluoroalkane is preferably separated off by distillation or by reducing the pressure. The reaction products are worked up by processes known to those skilled in the art. The reaction mixture is preferably heated. The reaction is preferably carried out as a one-pot reaction.

Preferably, the weight ratio of the C₁-C₅-difluoroalkane and/or cyclic C₅-difluoroalkane to the vinylaromatic polymer is 15:1 to 3:1. More preferably, the weight ratio of the C₁-C₅-difluoroalkane and/or cyclic C₅-difluoroalkane to the vinylaromatic polymer is 10:1 to 4:1.

The molar ratio of the aromatic groups in the vinylaromatic polymer to the compounds of formula (I) is preferably 0.2:1 to 2.5:1. The molar ratio of the aromatic groups in the vinylaromatic polymer to the compounds of formula (I) is more preferably 0.5:1 to 1.8:1.

The molar ratio of compounds of formula (I) to condensed formaldehyde is preferably 0.7:1 to 1.3:1. The molar ratio of compounds of formula (I) to condensed formaldehyde is more preferably 0.95:1 to 1.1:1.

The molar ratio of the compounds of formula (I) to the protic acid used is preferably between 10:1 and 1:10. The molar ratio of the compounds of formula (I) to the protic acid used is more preferably 1:1 to 1:10.

If the protic acid used is sulfuric acid, the concentration of the sulfuric acid used is preferably 70% by weight to 100% by weight. Even further preferably, the concentration of the sulfuric acid used is 90% by weight to 100% by weight.

The reaction temperature for the conversion of the vinylaromatic polymers to the amidomethylated vinylaromatic polymers is preferably 0° C. to 130° C. The reaction is preferably conducted at a pressure and a temperature at which the solvents are liquid. The pressure is preferably 1 to 60 bar. The reaction temperature is preferably 30° C. to 90° C.

The amidomethylated vinylaromatic polymers are, in particular, significant intermediates for the preparation of ion exchangers and chelating resins. It is thus possible, for example, to prepare ion exchangers, in particular anion exchangers, and chelating resins from the amidomethylated vinylaromatic polymers prepared by the process of the invention.

The amidomethylated vinylaromatic polymer is then convertible in a further step to aminomethylated vinylaromatic polymers. The amidomethylated vinylaromatic polymer is preferably converted further to aminomethylated vinylaromatic polymers. The conversion is preferably effected by treating the amidomethylated vinylaromatic polymer with aqueous or alcoholic solutions of an alkali metal hydroxide, such as sodium hydroxide or potassium hydroxide, at temperatures between 100° C. and 250° C., preferably at temperatures between 120° C. and 190° C. It is preferable to perform the conversion with alkali metal or alkaline earth metal hydroxides or mixtures of these compounds, more preferably with alkali metal hydroxides, such as in particular sodium hydroxide. The conversion is preferably carried out in the presence of an aqueous or alcoholic solution of an alkali metal hydroxide. The concentration of the sodium hydroxide solution is in the range from 10% to 50% by weight, preferably 20% to 40% by weight.

The aminomethylated vinylaromatic polymer formed here can be washed to free it of alkali with completely ion-free water.

The aminomethylated vinylaromatic polymer can be reacted with further alkylating agents to give anion exchangers or chelating resins, or else used as ion exchangers.

It is further possible to react the aminomethylated vinylaromatic polymers of the invention with halomethyl nitrogen heterocycles, e.g. 2-chloromethylpyridine, 3-chloromethylpyridine or 4-chloromethylpyridine, and thereby prepare chelating resins.

The present invention provides a novel process for preparing amidomethylated vinylaromatic polymers, with which in particular phthalimidomethylated polymers and aminomethylated polymers can be prepared in high yields while taking account of environmental considerations.

### EXAMPLE 1

### 1.1 Preparation of the Monodisperse Macroporous Polymer Based on Styrene, Divinylbenzene and Ethylstyrene

A 10 l glass reactor is initially charged with 3000 g of demineralized water and a solution of 10 g of gelatin, 16 g of disodium hydrogenphosphate dodecahydrate and 0.73 g of resorcinol in 320 g of deionized water is added and mixed in. The temperature of the mixture is adjusted to 25° C. Subsequently, while stirring, a mixture of 3200 g of microencapsulated monomer droplets having a narrow particle size distribution, composed of 3.1% by weight of divinylbenzene and 0.6% by weight of ethylstyrene (used in the form of a commercial isomer mixture of divinylbenzene and ethylstyrene with 80% divinylbenzene), 0.4% by weight of dibenzoyl peroxide, 58.4% by weight of styrene and 37.5% by weight of isododecane (technical isomer mixture having a high proportion of pentamethylheptane), is added, the microcapsule consisting of a formaldehyde-hardened complex coacervate composed of gelatin and a copolymer of acrylamide and acrylic acid, and 3200 g of aqueous phase having a pH of 12 is added.

The mixture is stirred and polymerized to completion by increasing the temperature in accordance with a temperature program commencing at 25° C. and ending at 95° C. The mixture is cooled, washed through a 32 μm sieve and then dried at 80° C. under reduced pressure.

This gives 1893 g of a polymer having a narrow particle size distribution. The average diameter of the pores in the polymer is 42 nm.

1.2. Preparation of a Phthalimidomethylated Monodisperse Macroporous Polymer with the Swelling Agent 1,3-Difluoropropane

A round-bottom flask is initially charged with 29.5 g of 1,3-difluoropropane. To this are added 4.1 g of polymer from example 1.1, 5.9 g (0.04 mol) of phthalimide and 1.2 g (0.04 mol) of paraformaldehyde (n=8 to 30) (96% by weight), and then the mixture is left to stir at room temperature for 30 min. 14.6 g (0.14 mol) of sulfuric acid (96% by weight) is added dropwise within 30 min, and then the mixture is stirred at 40° C. for 24 h. Thereafter, the beads are separated off on a sieve and washed with water, acetone and water.
Volume yield: 23 ml
Nitrogen content (after drying): 5.1% by wt.

In the context of the invention, yield means the degree of functionalization of the polymer as represented by the nitrogen content. This is greater in the inventive example than in the comparative example.

### EXAMPLE 2

### Comparative Example (Noninventive)

2.1 Preparation of a Phthalimidomethylated Monodisperse Macroporous Polymer with the Swelling Agent 1,2-Dichloroethane

A round-bottom flask is initially charged with 29.7 g of 1,2-dichloroethane. To this are added 4.1 g of polymer from example 1.1, 5.9 g of phthalimide (0.04 mol) and 1.2 g (0.04 mol) of paraformaldehyde (n=8 to 30) (96% by weight), and then the mixture is left to stir at room temperature for 30 min. 14.6 g (0.14 mol) of sulfuric acid (96% by weight) is added dropwise within 30 min, and then the mixture is stirred at 40° C. for 24 h. Thereafter, the beads are separated off on a sieve and washed with water, acetone and water.
Volume yield: 25 ml
Nitrogen content (after drying): 4.9% by wt.

1. Process for preparing amidomethylated vinylaromatic polymers, wherein at least one vinylaromatic polymer is reacted with at least one compound of formula (I) or salts thereof 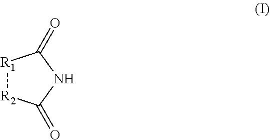
where R₁=—C(H(C₁-C₆-alkyl))- or —CH₂— and R₂=—C(H(C₁-C₆-alkyl))- or —CH₂— or R₁ and R₂ are two carbon atoms of an aromatic C₅ ring optionally substituted by one or two C₁-C₆-alkyl radicals, or R₁ and R₂ are each —CH═, and
at least one condensed formaldehyde
in the presence of at least one protic acid and
in the presence of at least one straight-chain or branched C₁-C₅-difluoroalkane or at least one cyclic C₅-difluoroalkane or mixtures of these compounds.

2. Process according to claim 1, wherein the C₁-C₅-difluoroalkanes are selected from the group of difluoromethane, 1,1-difluoroethane, 1,2-difluoroethane, 1,1-difluoropropane, 1,2-difluoropropane, 1,3-difluoropropane, 1,1-difluorobutane, 1,2-difluorobutane, 1,3-difluorobutane, 1,4-difluorobutane, 2,3-difluorobutane, 1,3-difluoro-2-methylpropane, 1,1-difluoropentane, 1,2-difluoropentane, 1,3-difluoropentane, 1,4-difluoropentane, 1,5-difluoropentane, 2,3-difluoropentane, 2,4-difluoropentane and 1,5-difluoropentane and mixtures of these compounds.

3. Process according to claim 1, wherein the C₁-C₅-difluoroalkanes used are difluoromethane or 1,3-difluoropropane.

4. Process according to claim 1, wherein the cyclic C₅-difluoroalkanes used are 1,1-difluorocyclopentane and 1,2-difluorocyclopentane.

5. Process according to claim 1, wherein the condensed formaldehyde used is paraformaldehyde or trioxane or mixtures of these compounds.

6. Process according to claim 1, wherein the vinylaromatic bead polymer used is a styrene-divinylbenzene copolymer.

7. Process according to claim 1, wherein the compound of formula (I) used is phthalimide or salts thereof.

8. Process according to claim 1, wherein the vinylaromatic polymer used is a monodisperse vinylaromatic polymer.

9. Process according to claim 1, wherein the pores of the vinylaromatic polymer used have a diameter of 25 nm.

10. Process according to claim 1, wherein the weight ratio of C₁-C₅-difluoroalkane to the vinylaromatic polymer is 10:1 to 4:1.

11. Process according to claim 1, wherein the molar ratio of the aromatic groups in the vinylaromatic bead polymer to the compounds of formula (I) is 0.5:1 to 1.8:1.

12. Process according to claim 1, wherein the molar ratio of compounds of formula (I) to condensed formaldehyde is 0.95:1 to 1.1:1.

13. Process according to claim 1, wherein the molar ratio of the compounds of formula (I) to the protic acid used is 10:1 to 1:10.

14. Process according to claim 1, wherein the reaction temperature for the conversion of the vinylaromatic polymers to the amidomethylated vinylaromatic polymers is between 30° C. and 90° C.
